(19) United States
(12) Patent Application Publication
(10) Pub. No.: US 2009/0246438 A1
(43) Pub. Date: Oct. 1, 2009

(54) RETROFIT PERMANENT HURRICANE WINDOW GLASS FILM PROTECTION

(76) Inventor: Phil Willhite, Spring Hill, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 12/403,407

(22) Filed: Mar. 13, 2009

Related U.S. Application Data
(60) Provisional application No. 61/070,916, filed on Mar. 27, 2008.

(51) Int. Cl. B32B 33/00

(52) U.S. Cl. 428/41.8

(57) ABSTRACT

A window glass film protection system with two laminate layers made from a polyester or a PET material, which are compressed together to sandwich an inner PVB layer until optimal clarity is achieved, using a heat extrusion process at a desired temperature. The heat extrusion process bonds the sandwiched layers together and reduces thickness for optical clarity in the film. An outside surface of one laminate layer has pressure sensitive adhesive with a releasable and removable backing laminate that is removed prior to the system being adhesively attached to a glass panel. The outside surface of the other laminate layer has a hardcoat layer, which is bonded to the exterior of the laminate layer by a heat adhesive bonding process to protect the product from abrasive damage and wear for longevity. All the components together are bonded by an installer to any window unit for a retrofit protection system.

### RELATED APPLICATION

This application claims the benefit of U.S. Provisional Patent Application Ser. No. 61/070,916 filed Mar. 27, 2008.

### FIELD OF THE INVENTION

The invention relates to laminated film protector for wind storm protection and security from glass breaking to enter premises.

### BACKGROUND OF THE INVENTION

Most hurricane damage results from wind pressure blowing in windows and the resultant entry of winds within the confines of a structure blowing the roof off. People in the home can be severely injured or killed from the blowing debris and collapsing structure.

There are many ways of protecting windows from wind damage. Some use plywood or other panels to cover the window. These take time to install and often people wait to install the panels when the winds have already started to gusts. Further, such panels do not allow light in the house and people often use candles when power is lost and this can lead to other problems such as fires. Panels also can leave unsightly areas around the windows such as mounting holes or studs that remain exposed.

There are companies that install films but many films used over the glass will not provide the protection of withstanding an impact from a projectile traveling in excess of 141 miles per hour.

### SUMMARY OF THE INVENTION

The invention is a multiple layer or laminate film window protection system. The main component comprises two laminate layers made from a polyester material, PET material or one layer from each material, which are compressed together to sandwich an inner PVB layer until optimal clarity is achieved, using a heat extrusion process at a desired temperature, preferably about 200° F., but higher temperatures may be used for even better results. The heat extrusion process bonds the sandwiched layers together and reduces thickness for optical clarity in the window glass film protection system.

An outside surface of one of the two laminate layers has pressure sensitive adhesive with a releasable and removable backing laminate that is removed prior to the inventive system being adhesively attached to a glass panel to be protected by the inventive system. The outside surface of the other laminate layer has a hardcoat layer, which is bonded to the exterior of the laminate layer by a heat adhesive bonding process by the PET laminate manufacture to protect the product from abrasive damage and wear for longevity. All the components together are bonded by an installer to any window unit for the retrofit window glass film protection system.

### BRIEF DESCRIPTION OF THE DRAWINGS

In the accompanying drawings:

FIG. 1a is an exploded side view of the invention;

FIG. 1b is a compressed side view of the laminated layers of the invention;

FIG. 2a is an exploded perspective view of the PET layers with the PVB layer sandwiched between;

FIG. 2b is a frontal view of the invention applied to a glass panel of a window; and

FIG. 3 is a frontal view of the invention applied to the glass panels of a double hung window.

### DETAILED DESCRIPTION OF THE INVENTION

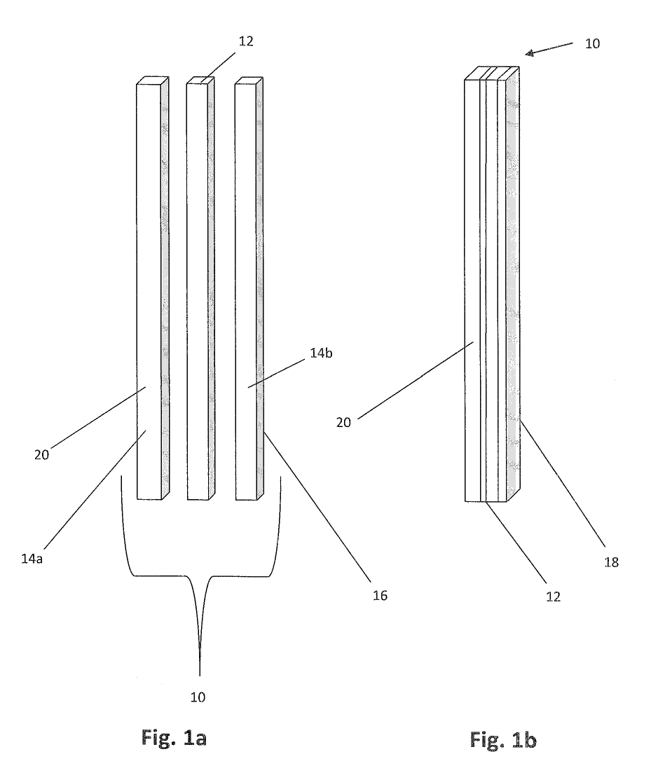

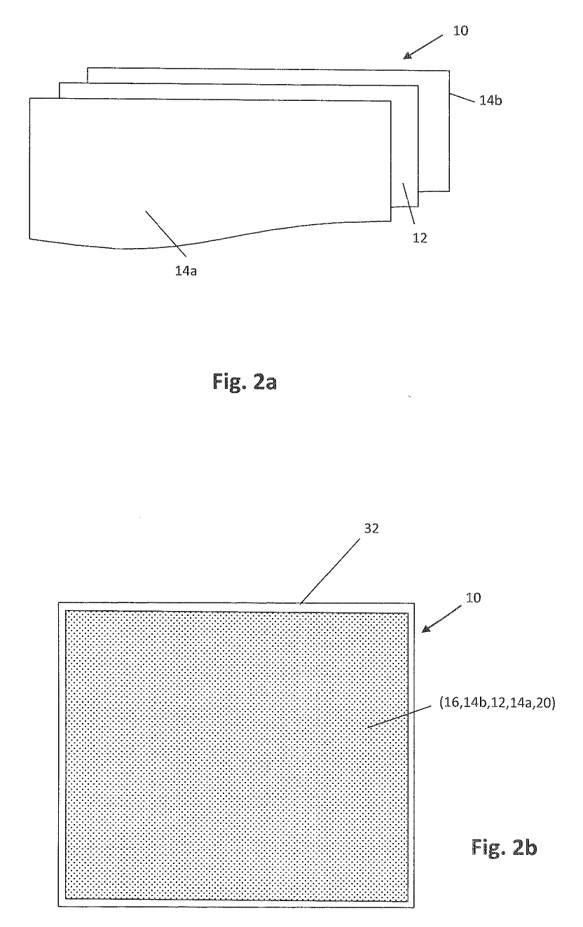

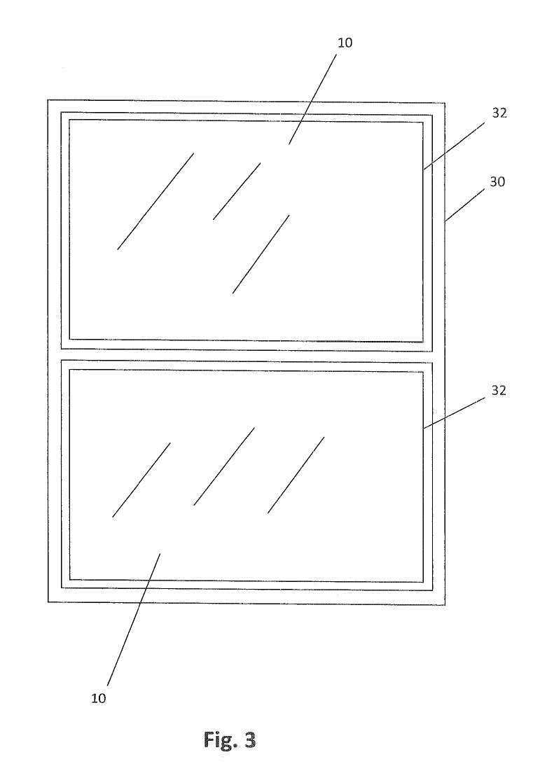

Referring now to the drawings, FIGS. 1a, 1b, 2a, 2b and 3 disclose, which is a window glass film protection system to protect window glass from damage due to projectile impacts caused by winds during wind storms such as hurricanes, and is depicted generally as 10.

Accordingly, the invention is a window glass film protection system 10 to protect window glass 32 in a window 30 installed on a building from damage due to projectile impacts caused by winds during wind storms, the system 10 comprising a multiple layered laminate film comprising two laminate layers 14a,14b, which are compressed together to sandwich an inner PVB (plastic or cellophane) layer 12 at a desired temperature to achieve a desired clarity. The two laminate layers may both be made from a polyester material or from a PET material or one layer of each material may be used.

An outside surface of one of the two laminate layers 14b has a pressure sensitive adhesive 16 with a releasable and removable backing laminate 18 that is removed prior to the system 10 being adhesively attached to a glass panel 32. An outside surface of the opposite of the two laminate layers 14a has a hardcoat layer 20, which is bonded to an exterior of the opposite laminate layer 14a by a heat adhesive bonding process to protect the system 10 from abrasive damage and wear.

The two laminate layers 14a,14b are compressed together with the sandwiched inner PVB layer 12 using a heat extrusion process, which bonds the sandwiched layers together and reduces thickness for optical clarity in the resultant film forming the inventive system. The desired temperature for compressing the two laminate layers 14a,14b together with the sandwiched inner PVB layer 12 is preferably about 200° F., but higher temperatures may be desired if even more optimal clarity is required or desired.

The calculated minimum yield strength for the inventive film is 33,000 pounds per square inch. The maximum yield strength is estimated to be significantly higher but the exact number has not been determined since the film has not yet been tested to a fail point. This minimum calculation is required to pass Florida's Dade County Protocol Pa-203.

The film has passed Dade County Protocol Pa-201, Pa-202, and Pa-203 impact testing.

The film thickness ranges from about 8 mil thick to about 20 mil thick.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A window glass film protection system to protect window glass from damage due to projectile impacts caused by winds during wind storms, the system comprising:
a multiple layered laminate film comprising two laminate layers, which are compressed together to sandwich an inner PVB layer at a desired temperature to achieve a desired clarity, wherein said laminate layers are both made from a polyester material or a PET material, or one of said laminate layers is made from said polyester material and the other of said laminate layers is made from said PET material;
an outside surface of one of said two laminate layers having a pressure sensitive adhesive with a releasable and removable backing laminate that is removed prior to said system being adhesively attached to a glass panel to be protected by the system; and
an outside surface of an opposite of said two laminate layers having a hardcoat layer, which is bonded to an exterior of said opposite of said two laminate layers by a heat adhesive bonding process to protect the system from abrasive damage and wear.

2. The system according to claim 1, wherein the two laminate layers are compressed together with the sandwiched inner PVB layer using a heat extrusion process, which bonds the sandwiched layers together and reduces thickness for optical clarity in the film.

3. The system according to claim 1, wherein the desired temperature for compressing the two laminate layers together with the sandwiched inner PVB layer is about 200° F.

4. The system according to claim 1, wherein the desired temperature for compressing the two laminate together with the sandwiched inner PVB layer is 200° F. or higher so as to achieve a desired clarity.

5. The system according to claim 1, wherein said window glass film protection system has a yield strength of at least 33,000 pounds per square inch.

6. The system according to claim 1, wherein said window glass film protection system has a thickness ranging from about 8 mil thick to about 20 mil thick.
